(19) United States
(12) Patent Application Publication
(10) Pub. No.: US 2003/0023498 A1
(43) Pub. Date: Jan. 30, 2003

(54) Method of buying and selling goods and services

(75) Inventor: William M. Benton, Fort Lauderdale, FL (US)

Correspondence Address: HOLLAND & KNIGHT, LLP, ONE EAST BROWARD BLVD., SUITE 1300, FT LAUDERDALE, FL, 33301

(73) Assignee: Day Money, inc.

(21) Appl. No.: 09/915,064

(22) Filed: Jul. 25, 2001

(51) Int. Cl. G06F 17/60

(52) U.S. Cl. 705/26

(57) ABSTRACT

A method in which a group of financial institutions and member businesses cooperate to establish a trading network in which member sellers accrue derivatives equal to the value of sales of goods or services to member buyers, and then use the derivatives to purchase items from other members of the network. No money is transferred in the course of the transactions, but the financial institutions act as guarantors to ensure that the derivatives exchanged for goods or services are backed by U.S. dollars or another international currency of choice.

### FIELD OF THE INVENTION

This invention relates to the purchase and sale of goods and services, and, more particularly, to a method of buying and selling goods and services among members of a trading network including financial institutions in which derivatives are accumulated by members as a result of sales and then used to make purchases from other members of the network. Excess derivatives may be redeemed for cash at variable discount rates from participating financial institutions.

### BACKGROUND OF THE INVENTION

Many newly organized and existing businesses face a variety of challenges in securing sufficient funds to finance ongoing operations and growth. An increasingly pervasive problem in recent years has been the trend for purchasers of goods or services to delay payment over longer and longer periods of time. Whereas payment cycles had been 30 days or less in the past, it is not uncommon today to have accounts receivables on the books in the 45 to 90 day range or more. This severely hampers the ability of a business to purchase new products, or expend funds on expansion, unless the size and credit history of the business allows it to obtain lines of credit from a bank or other financial institution. For many businesses, such lines of credit are not available, or can be obtained only at unacceptably high interest rates.

A number of options are available to assist businesses with cash flow and the generation of funds for operations or expansion, but each has inherent limitations and risks. As noted above, many buyers have chosen to extend the time of payment for their purchases well beyond historic 30 day cycles. While delays in payment allow a buyer to retain funds for a longer period of time to accrue interest or be put to other uses, the seller's cash flow suffers and inhibits it from making purchases of goods or services from others. Eventually, the entire system is slowed because the buyer who deferred its payment to a seller ultimately suffers delays in the purchase of and payment for its own goods by others because prospective buyers have not received payment on their receivables. For those businesses who are unable to obtain satisfactory lines of credit, this cycle is difficult to break.

Banks and other financial institutions have aggressively promoted the use of credit cards, both at the consumer level and for use by businesses. Although widely accepted, credit cards have a number of pitfalls for all parties involved. Sellers of goods or services who accept credit cards typically pay a fee to the issuer of the card in the range of about 3-4% of the purchase, plus monthly fees to remain on the system. Additionally, payment from the issuer for the amounts charged by buyers may be delayed up to 10 days or more, which impacts the cash flow of the seller. From the standpoint of the issuer of the card, purchases made on a credit card automatically become a loan to the buyer and are debited to the issuer. While the financial institutions which issue cards have an opportunity to qualify those who receive one, and set credit limits, defaults on the “loans” or credit extended to card holders are common and losses can be significant over time. The same features of credit cards which are attractive to card issuers are a detriment to card holders. If cash flow is insufficient to pay off balances when due, the card holder will be required to pay interest on the unpaid balance which can exceed 18% per annum. This is a huge source of income to the issuers, but a real burden to the card holder. Moreover, businesses with little credit history, and/or businesses with poor credit ratings, often do not qualify for credit cards, or if they do, the credit limit is set at a comparatively low amount.

Another source of funds which businesses are often forced to utilize is known as “factoring.” This term refers to the practice of obtaining funds from a lender by pledging or assigning the accounts receivable of the business as collateral. Due to the increasingly longer delays in obtaining payment for receivables, as noted above, many businesses have been forced to employ factoring to generate cash. One problem with this alternative is that it is expensive, e.g., the bank or other financial institution which provides funds based on the accounts receivables of a given company typically charges as high as 15% of the value of the receivable. Additionally, most states have laws requiring the buyer to disclose to a seller that it is purchasing goods or services by factoring its receivables. Many consider this to be an indication of financial weakness, and it may result in the cancellation of a purchase, presently or in the future, or a modification of the amount or terms of a pending sale.

Still another method of trading which has existed for ages, known as bartering, is sometimes used by businesses. Bartering comprises the exchange of goods and/or services of one party for those of another without the transfer of money between the parties. It has been found that this method of doing business often results in problems with valuation of the goods or services to be traded, usually where one or both parties assigns an inflated value to their contribution to the transaction. Additionally, no bank or other entity stands in the position of a guarantor, and therefore the parties are left with little recourse in the event of a default or non-performance.

### SUMMARY OF THE INVENTION

It is therefore among the objectives of this invention to provide a method of buying and selling goods and services among members of a trading network including financial institutions which substantially increases the availability of funds, which creates faster turnover of proceeds from sales between members, which reduces the risks among members of default or non-performance by other members, which reduces risk to participating financial institutions and thus permits lower transactional charges, which provides a guarantor to each transaction, which generates additional sources of revenue for the financial institutions, which eliminates up-front capital contributions by all parties, which provides for redemption of member equity in U.S. dollars, which employs existing infrastructure including credit card systems, account processing, record keeping and data processing, and, which requires periodic settlement of negative account balances.

These objectives are accomplished in a method according to this invention in which a group of financial institutions and member businesses cooperate to establish a trading network in which member sellers accrue derivatives equal to the value of sales of goods or services to member buyers, and then use the derivatives to purchase items from other members of the network. No money changes hands in the course of the transactions, but the financial institutions act as guarantors to ensure that the derivatives exchanged for goods or services are backed by U.S. dollars or other international currency of choice.

The method of buying and selling goods or services according to this invention is predicated on the concept of substantially reducing the time interval between the sale of a product or service by a seller, and the availability of the proceeds from the sale for use by that seller in the purchase of another product or service from someone else. Unlike current systems in which funds are tied up in accounts receivable for 45 to 90 days or more, the proceeds of a sale among members of the trading network herein are available in the form of transferable derivatives within 24 to 48 hours from the sale. As a result, the seller in the original transaction has the means to become a buyer in another sale within a day or two, thus effectively increasing the value of the proceeds from the initial purchase because of the rapid turnover of funds from one party to the other.

In the practice of the method of this invention, each prospective participant in the network is carefully screened by a financial institution such as a bank, so that credit worthiness and stability is ensured before approval as a network member. Each bank sets a credit limit, a minimum required reserve, assigns an account number and issues a card somewhat similar to a credit card for each member it approves. No party is required to contribute capital to the network, but each member must allow its bank to hold a minimum number of derivatives, once it makes sales within the network, which comprises the required reserve. A “derivative” essentially corresponds to one U.S. dollar or other currency of choice, except it is not cash as such but a numeric designation used to quantify the value of the goods or services exchanged in a sale among members of the network.

Sales take place among network members in a manner generally similar to typical transaction over the Internet, a sale using a credit card or a purchase involving direct contact between the buyer and seller via phone, fax or e-mail. Once identified as a network member, credit data is obtained from the buyer by the seller and transmitted to a central processor which maintains real time records of the “working balance” of each member, i.e., the sum of available credit, and the balance of purchases and sales as of that point in time for each member, expressed in terms of derivatives. If the working balance of the prospective buyer is greater than the transaction amount, the sale can be approved and all parties, including the buyer's and seller's banks, receive a record of the transaction. Depending upon the requirements of the seller's bank, the derivatives received by the seller for the transaction are made available to spend within a day or two after the sale is initiated to allow for correction of errors.

In the presently preferred embodiment, an account reconciliation or settlement is required of each member's account once a month. If the balance of purchases made by the member is greater than the value of its sales as of the reconciliation date, e.g., a negative balance, the member must pay cash to its bank or execute additional sales to generate derivatives in order to make up the difference. On the other hand, if the member's account shows a positive balance, the member has the option of redeeming excess derivatives for cash at a discount rate which varies depending on the magnitude of the surplus.

The method of this invention has a number of advantages for all participants. Considering the member businesses, one significant benefit is the substantial reduction in time within which funds from a sale are made available to the seller for use, i.e., from current 45 to 90 day delays to 2 days, as noted above. As such, funds can be “turned over” or used by the members a number of times in a single month, instead of once every two to three months under the current accounts receivable system. Additionally, member businesses have less risk of bad debt and non-performance than in typical transactions. All members have been carefully screened by their banks before they are allowed to participate in the network, and each transaction is separately approved or declined depending on the records of a central server which maintains real time updates of each member's working balance, as described above. Further, the transactions are guaranteed by the participating banks or other financial institutions.

The financial institutions or banks also enjoy a number of significant benefits under the method of this invention. Each bank is a broker, not a lender. Unlike credit cards, for example, the derivatives which are exchanged between a buyer and a seller in one network transaction accrue from sales previously executed by the buyer in other transactions. Although the banks do assign a credit limit to each of its members which can be used in network exchanges, derivatives primarily result from sales with which the banks do not become involved. A number of safeguards protect each bank. First, a credit screening process is undertaken before any member is accepted. Credit limits are assigned by the bank in accordance with the credit history and rating of a member, and each member is required to maintain a required reserve with its bank equal to a predetermined number of derivatives generated by sales made by such members. The required reserve contributions made by the members may be placed in interest bearing accounts by the bank to generate money. No up front money need by contributed by the banks. Additionally, as noted above, each member account is reconciled on a monthly basis, for example, and any negative balances must be paid in cash or derivatives to the banks by the member(s) in order for them to participate in future exchanges.

Although the banks may be asked to redeem derivatives for cash by qualifying members, as described below, the magnitude of such redemptions is limited by the required reserve amounts. Moreover, the banks are authorized to charge varying discount rates for the redemption of derivatives, which provides a further source of income. In some instances, banks may choose to extend additional credit to selected, qualifying members, e.g., to cover negative account balances as of the account reconciliation date, and the interest made on such credit is another income source. Banks may use the present transfer network to generate additional business clients who may need other banking services, and the method herein is one way to assist struggling and/or start up businesses with minimal risk since the accrual of derivatives is dependent upon sales and not loans from the bank. These start up customers may become larger, more valuable customers for the bank over a period of time.

With the numerous advantages to the financial institution participants of the trading network herein, it is anticipated that the operating expenses can be made comparatively low. This allows the banks to offer nominal discount rates at which derivatives may be redeemed, as well as reductions in the cost of other member services. Moreover, because existing credit card, data processing, account records and other infrastructure can be employed with the method of this invention, there is limited need for additional equipment or training for the personnel of the participants. This benefits all parties, and permits the method herein to be implemented with minimum expense and delay.

### DESCRIPTION OF THE DRAWINGS

The operation and advantages of the presently preferred embodiment of the method of this invention will become further apparent upon consideration of the following description, taken in conjunction with the accompanying drawings, wherein:

FIG. 1 is a flow chart showing the sequence of events to qualify a prospective participant in the trading network herein as a member;

FIG. 2 is a flow chart representative of a portion of the purchase sequence of the subject method;

FIG. 3 is a flow chart showing the credit approval process represented by the box at the bottom of FIG. 2; and

FIG. 4 is a flow chart illustrating the account reconciliation procedure of the method of this invention.

### DETAILED DESCRIPTION OF THE INVENTION

With reference now to the drawings, the method of this invention is schematically depicted by a several flow charts which are representative of a sequence of events and operations performed by or on behalf of the network participants. Each flow chart contains a number of “boxes” identified by reference numbers, which, for ease of discussion, denote an event or operation in the method herein. For purposes of the present discussion, it is presumed that one or more financial institutions or banks have joined together with a service provider, identified as the “central processor” as discussed below, to establish the trading network of this invention. These banks then solicit and establish a membership among their existing business accounts, and other businesses, according to rules and procedures to be described. The resulting “trading network” therefore comprises the participating banks, member businesses and the central processor who interact via computer, telephone, fax or other means to execute the trading method of this invention.

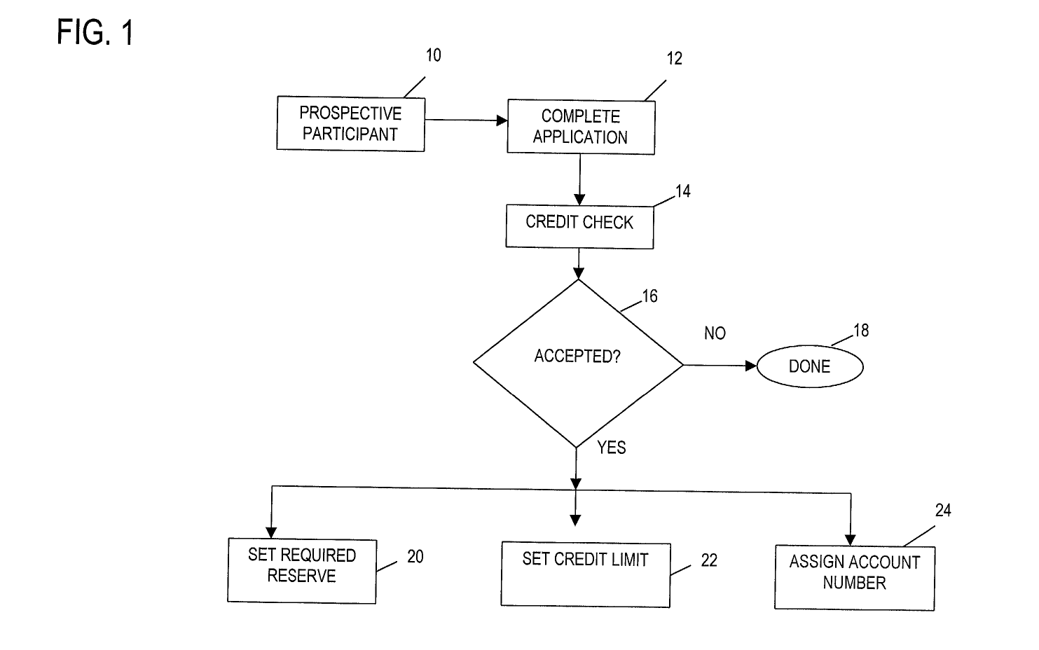

Referring initially to FIG. 1, the sequence of events to qualify a member of the trading network is schematically depicted. A prospective participant 10 in the network is solicited or requests to fill out an application, represented by box 12, for membership in the network. The application contains whatever credit information the participating bank requires, and a credit check 14 is undertaken which is not unlike one which would typically be required for a business seeking a loan, line of credit, credit card or the like. Boxes 16 and 18 are intended to represent that not all applicants will be accepted, but for those that are an account is established. It is contemplated that in initially organizing the trading network, the bank(s) will establish substantially uniform, or at least minimum, criteria for credit approval and the opening of an account for a new member business. For each member, its bank will set a minimum required reserve as at box 20, a credit limit 22 and provide an account number 24 which appears on a card (not shown) issued by the bank similar to a credit card.

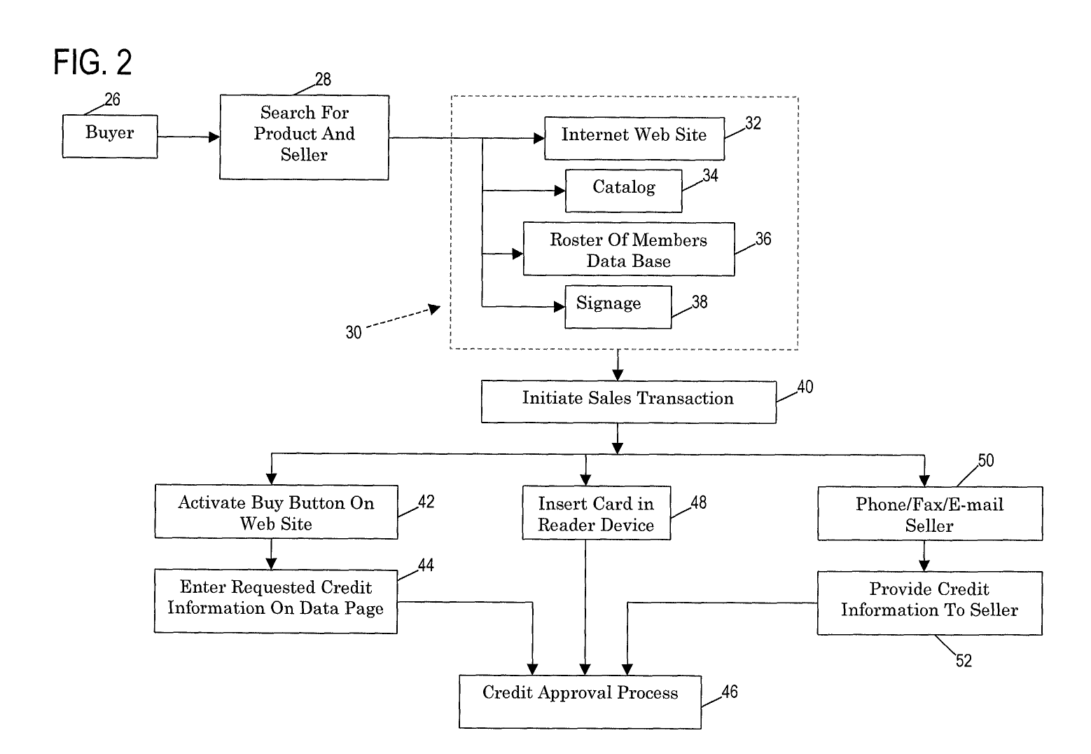

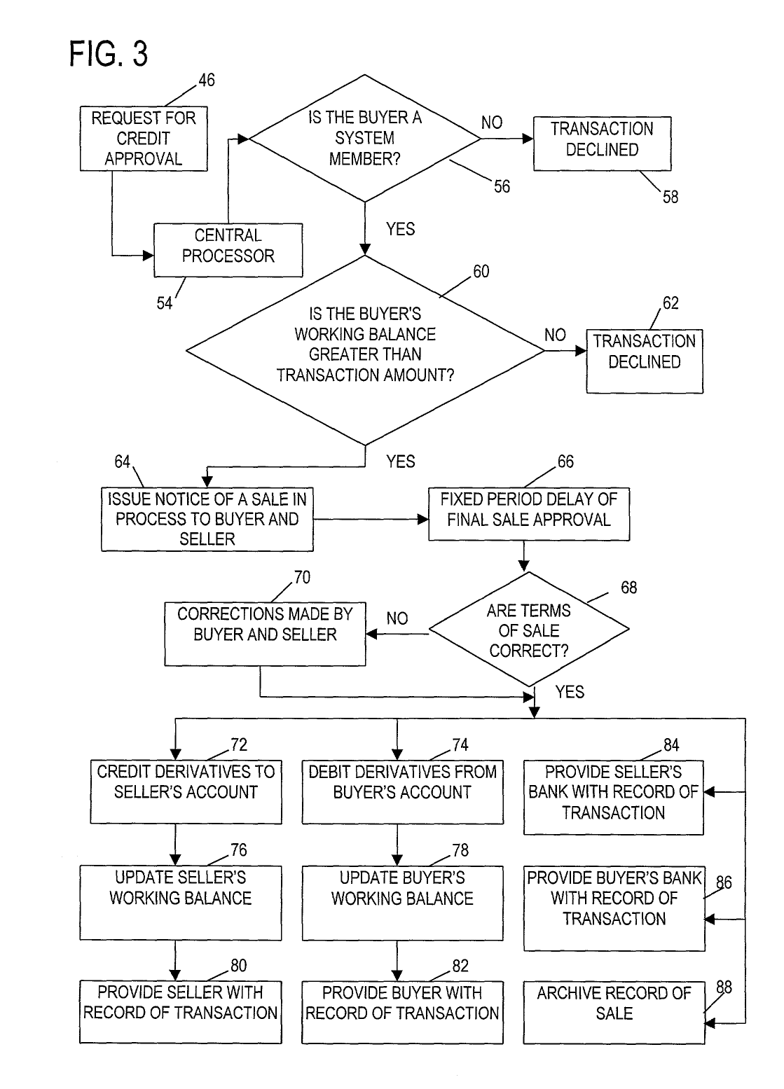

Trading in the network of this invention, in the manner described more fully below with reference to FIGS. 2 and 3, takes place between member buyers and sellers who exchange “derivatives,” instead of money. As noted above, a derivative essentially corresponds to one U.S. dollar, or other mutually agreed upon currency unit, except it is not cash as such but represents a numeric unit used to quantify the value of the goods or services exchanged in a sale among members of the network. The required reserve 20 represents a minimum number of derivatives which the bank is permitted to retain from sales made within the network by each member. No up-front cash payment is required of a member business at the inception of its participation in the network, but a portion of its initial sales of goods or services to another member is retained by its bank for the required reserve 20. The bank is free to convert the required reserve 20 to cash and invest same in an interest bearing account or other investment of its choice to generate funds.

The credit limit shown in box 22 is also set by a member's bank in terms of derivatives, the magnitude of which is based upon the credit worthiness of a given member. As discussed, the member banks will likely adhere to jointly agreed upon criteria in setting credit limits to ensure that the financial integrity of the network is protected.

Referring now to FIG. 2, a schematic depiction is provided of the initial steps for the purchase of goods or services among members of the network. Initially, a network member identified as the “buyer,” as at box 26, undertakes a search 28 for a product or service of interest and/or a particular seller. This search may involve one or more of the sources collectively depicted in the box 30, shown in phantom, including, without limitation, the Internet web site 32 of the seller, a catalog 34 or other publication, a roster of members 36 of the network, signage 38 located at members' places of business and essentially any other source. With respect to the “roster of members 36” of the network, it is contemplated that over a period of time a data base of members and the goods or services each offers will be developed and provided to each network member via an Internet web site or printed listing in a directory or the like.

Once the buyer 26 has located a product or service of interest, the actual sales process is initiated as at box 40. In the context of a transaction which takes place over the Internet, i.e. where the buyer 26 locates something to buy at the web site 32 of a member seller, the buyer 26 first activates the buy button 42 to indicate its intention to purchase a given product or service. As with conventional Internet sales, a data page appears and the buyer 26 is prompted to enter certain credit information represented at box 44 in FIG. 2. The form and content of the data page for sales among members of the network may vary to some extent from web site to web site, but common information would include the name and address of the buyer 26 and information concerning its network account such as the account number 24. Once the data page is completed, a request for credit approval is initiated as denoted by box 46 in FIG. 2, which is discussed in detail with reference to FIG. 3 below.

In addition to Internet-based sales, transactions among members of the network can take place in a manner similar to conventional point-of-purchase sales or direct contact methods. As schematically shown in box 48 at the bottom of FIG. 2, a member buyer may employ its card issued as part of the credit approval process of FIG. 1 to purchase an item at the place of business of a member seller. The card 48 would be swiped in a reader device of the type commonly used in credit card sales, and data would be entered by the seller relating to the purchase amount for transmission to box 46 and the beginning of the credit approval process. Alternatively, the buyer may contact the seller directly via phone, facsimile, e-mail or the like, as at box 50, to convey its intention to purchase a product or service. Essentially the same credit information entered into the data page at the web site of an Internet transaction (box 44), would be obtained by the seller in this type of direct contact sale, as depicted at box 52. Such information is then transmitted to box 46 to begin the credit approval process, as noted above.

Referring now to FIG. 3, the credit approval process and execution of the sale between network members is diagrammatically illustrated. As noted above, the network of the subject invention is initially formed by one or more financial institutions and a “service provider” designated as a central processor 54 in FIG. 3. The central processor 54 is an entity which maintains a server and ancillary equipment capable of storing and processing data generated in the course of operation of the network. Such data includes, for each member, its account number, amount of required reserve, amount of actual reserve, working balance, credit limit, amount of available credit, balance of recorded sales, identity of the member's bank and other information. This data is updated on a real time basis for use in the transaction approval process as described below, and the central processor 54 is connected via the Internet, e-mail, fax or other means to each member and to each bank.

The request for credit approval 46 is transmitted from the seller to the central processor 54 where an initial inquiry is made as to whether the buyer 26 is a member of the network. See box 56. If not, the transaction is declined, as denoted by the “no” arrow from box 56 to box 58. The next inquiry made in the data base of the central processor 54 is to compare the working balance of the buyer 26 with the transaction amount, e.g. the purchase price of the goods or services desired. See box 60. The term “working balance” refers to the sum of the “available credit” of the buyer 26 and its “balance of recorded sales.” As noted above, each member is assigned a credit limit 22 upon entry into the trading network, corresponding to a number of derivatives. Sales by each member result in a credit of derivatives to the seller's account, as discussed more fully below. On the other hand, when a member purchases a service or product, its account is debited by the number of derivatives equal to the value of such purchase. The “balance of recorded sales” therefore refers to the amount of derivatives credited to a member's account due to its sales to other members, less the number of derivatives it has spent on purchases within the network. If that balance is negative, derivatives can be obtained from the credit assigned to a member up to its credit limit 22. As such, the term “available credit” refers to the difference between the assigned credit limit 22 of the member and the number of derivatives of credit which that member has used in prior purchases.

The balance of recorded sales, the available credit and the sum of the two, or working balance, is calculated and stored in the server of the central processor 54 on a real time basis. As noted in box 60, the server has the capability of comparing the working balance to the transaction amount in a proposed sale. If the working balance of the member buyer is not greater than the transaction amount, the central processor 54 declines the transaction as indicated by the “no” arrow extending from box 60 box 62. In the event the central processor 54 determines that the working balance of the buyer is greater than the transaction amount (see “yes” arrow from box 60), a notice of the pending sale is sent to the buyer and to the seller involved in the transaction a denoted in box 64, Additionally, a temporary “hold” or fixed period of delay is instituted before the transaction is finalized. See box 66. The purpose of these procedures is to allow each of the participants in the sale to review the details of the transaction, e.g., the purchase price and item or service which is the subject of the sale, to make sure the records of the central processor 54 are accurate and correctly reflect the intent of the parties. A check or review of the transaction details is denoted by box 68, and provision is made for the parties to contact the central processor 54 to correct errors in the sale as recorded. See box 70.

The period of delay or pendency of a transaction is typically one to two days, unless a problem develops between the buyer and seller. Assuming that such period passes, the sale is finalized and the operations shown at the bottom of FIG. 3 are executed by the central processor 54. An amount of derivatives equal to the value of the transaction amount are credited to the seller's account as at box 72 and debited to the buyers account as denoted by box 74. The working balance of both the seller and buyer is updated as at boxes 76 and 78, respectively, and each party is provided with a record of the transaction. See boxes 80 and 82. The central processor 54 also provides the sellers bank and the buyer's bank with a record of the transaction, as shown in boxes 84 and 86, and the details of the sale are archived in the server of the central processor 54 as represented by box 88. A service fee may be charged by each of the buyer's and seller's bank to their respective customers, as part of the transaction.

One important aspect of the method of this invention is to ensure the accounts of each of the members remain current. In the presently preferred embodiment, an audit of each account is conducted on the 10^{th} of each month based upon the balance of sales for the period extending between the 25^{th} of each of the two prior months. For example, an audit conducted on June 10^{th} would examine the balance of sales for each member during the period from April 25^{th} to May 25^{th} with the balance of the month of May and the first 9 days in June being carried over to the July 10^{th} audit. Although the 10^{th} and 25^{th} days of the month are discussed herein, it should be understood that essentially any other dates could be chosen, as desired.

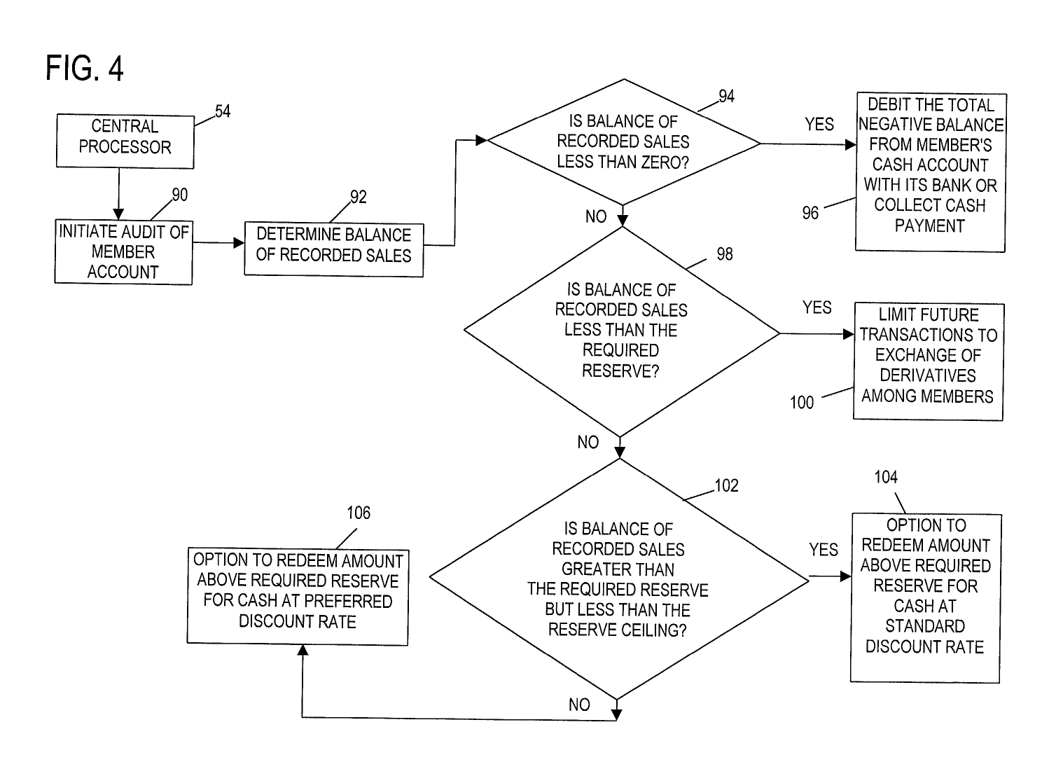

With reference to FIG. 4, the audit process is schematically illustrated. The central processor 54 initiates the audit as at boxes 90 and 92 by first determining the balance of sales as reflected in the account of each member for the applicable period. As denoted in box 94, the central processor 54 first determines whether or not the balance of recorded sales of a given member is less than zero, e.g., a negative balance. If so, as indicated by the “yes” arrow from box 94, the member is required to contribute an amount of cash sufficient to bring its account balance to zero. See box 96. It is contemplated that in many instances a member will maintain a cash account with its bank, such as a savings or money market account, and after notification by the central processor 54 of the negative balance the bank debits the cash account of the member to make up the deficiency in its network account balance. In the event a member does not maintain a cash account with its network bank, such member would be required to make a cash payment to the bank to cure the negative balance. Alternatively, the negative balance in the member's account could be made up with sales to others in the network in lieu of a cash payment.

It should be noted that the “negative balance” referred to in this aspect of the method herein does not take into account the reserve of a given member, i.e., each member is required to maintain its required reserve 20 at all times, and such funds are not available for use as payment for a transaction within the network. Additionally, this feature of the subject method provides a means of “de-listing” a member having financial difficulty at an early stage and with minimum difficulty. In the event the member is unable to return its account from a negative balance to zero, or a positive balance, the central processor 54 and its bank will immediately decline any further transactions of that member in the network until such time as the negative balance has been eliminated. As such, both the banks and other network members are protected from circumstances which can be lead to payment delinquencies and other problems by the present method.

Assuming the account of a member has a positive balance, the next inquiry made by the central processor 54 is to determine if the balance of recorded sales is less than the required reserve as represented by box 98. If the answer to that query is “yes,” as expressed by the arrow from box 98, then a restriction is applied to future trades of such member until the next audit is conducted. As shown in box 100, such member is limited to transactions involving an exchange of derivatives among members of the network, and it is not eligible to redeem derivatives for cash, as described below. For example, if the cash reserve set by the bank of a member is 2000 derivatives, and the balance of derivatives from network purchases and sales of such member is 1000, any future transactions of the member until the next audit would be limited to purchases having a value of 1000 plus any available credit. The purpose of this restriction is to encourage members to maintain an appreciable account balance, and to provide a safeguard to the network banks against the redemption of derivatives for cash where a member's account is at a comparatively low positive balance.

As noted above, a required reserve of derivatives is retained by each bank from its members generated by the sales made by such members to others in the network. This required reserve 20 may be on the order, for example, of 2000 derivatives for a typical member. A “ceiling reserve” is preferably also set for each member by its bank, which can be, for example, 5000 derivatives per member. As represented in boxes 102, 104 and 106, redemption of derivatives for cash depends on the number of derivatives which are maintained in a given member's account in comparison to the required reserve and the ceiling reserve. With reference to box 102, the central processor 54 calculates whether the balance of recorded sales is greater than the required reserve 20 but less than the reserve ceiling. If the answer is “yes” as represented by the “yes” arrow from box 102, then the member is permitted to redeem the number of derivatives in excess of the required reserve at a “standard” discount rate, e.g. on the order of 3-4%. See box 104. Alternatively, if the balance of recorded sales of such member is greater than the reserve ceiling, denoted by the “no” arrow from box 102, then the member is permitted to redeem for cash the number of derivatives in excess of the reserve ceiling at a preferred discount rate on the order of 1-2%. For example, assuming a required reserve of 2000 derivatives and a reserve ceiling of 5000 derivatives, a member with a balance of recorded sales equal to 3000 derivatives would be permitted to redeem 1000 derivatives for cash at a discount rate of 3-4%. If a member had a balance of recorded sales equal to 7500 derivatives, it could redeem 2500 derivatives for cash at a discount rate of 1-2%, and, if desired, an additional 3000 derivatives for cash at a discount rate of 3-4%.

It is noted that sellers who accept standard credit cards incur a charge of 3.5% or more, including monthly fees, for each purchase. The standard discount rate for the method of this invention is no more than such credit card fees, and the preferred discount rate is less. Moreover, business checking accounts bear no interest. Consequently, there is no net loss and potential benefits for members to maintain at least some amount of derivatives in their network accounts. From the standpoint of the network banks, the members are given an incentive to maintain more derivatives in their accounts by changing comparatively low discount rates so that more funds are available to the banks for investment and income generation. If a network bank had 100,000 member clients, each provided with an incentive to maintain 5,000 or more derivatives on account, such bank has generated $500 million of funds to invest. Given the relatively small investment required of the banks, both in terms of infrastructure and payment to members, substantial sums can be earned by the banks even allowing redemption of derivatives at preferred discount rates.

While the invention has been described with referenced to a preferred embodiment, it should be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of buying and selling goods and services among members of a network including financial institutions, comprising:
(a) conducting a credit check on prospective participants in the network;
(b) assigning a credit limit of derivatives to each participant which has qualified as a network member;
(c) assigning a required reserve contribution for each member for deposit with its financial institution;
(d) determining a working balance of derivatives for each member equal to the sum of available credit from the assigned credit limit and the balance of recorded sales of goods or services made by that member;
(e) executing a transfer of goods or services between members of the network including:
(i) transmitting a purchase request from a member buyer to a member seller;
(ii) approving the purchase request in the event the amount of the purchase is less than the working balance of derivatives of the member buyer;
(iii) crediting derivatives to the working balance of the member seller equal to the amount of the purchase; and
(iv) debiting derivatives from the working balance of the member buyer equal to the amount of the purchase.

2. The method of claim 1 in which step (a) includes submitting a credit application to a financial institution within the network, and having said financial institution conduct a credit check of the prospective participant.

3. The method of claim 2 in which step (b) includes having said financial institution assign a credit limit to each member it qualified, said financial institution guaranteeing an amount of derivatives equal to the assigned credit limit of each of said member.

4. The method of claim 1 in which step (c) includes establishing a minimum required reserve contribution for each member dependent on the financial history of said member.

5. The method of claim 4 in which step (c) includes establishing a reserve ceiling contribution for each member which is greater than the minimum required capital contribution.

6. The method of claim 1 in which step (c) includes permitting each financial institution to maintain the collected required reserve contribution in an account of its choice.

7. The method of claim 1 in which step (d) includes maintaining a central processor having a data base containing records of the assigned credit limit, the amount of available credit, the balance of recorded sales, and the financial institution, for each member.

8. The method of claim 7 in which step (d) includes assigning a value to the presently available credit, and to the balance of recorded sales, in terms of derivatives.

9. The method of claim 7 in which step (d) includes recording the amount of sales made by each member and the amount of purchases made by each member.

10. The method of claim 1 in which step (e)(ii) includes transmitting the purchase request to a central processor having a data base containing the amount of available credit and the balance of recorded sales of the buyer member.

11. The method of claim 10 in which step (e)(ii) includes comparing in the data base of the central processor the purchase amount with the sum of the available credit and the balance of recorded sales of the member buyer, and approving the purchase request in the event said sum is greater than the purchase amount.

12. The method of claim 11 in which the step of approving the purchase request comprising issuing a notice of a pending sale to the member buyer and to the member seller involved in the transaction, and delaying finalization of the sale for a selected time period.

13. The method of claim 12 in which the step of approving the purchase request further includes permitting the member buyer and the member seller to provide corrections to the data of the central processor, before the sale is finalized, in the event of an error.

14. The method of claim 1 in which steps (e)(ii) and (e)(iv) further include the financial institution charging the member buyer with a service fee.

15. The method of claim 1 in which step (e) (iii) further includes the financial institution charging the member seller with a service fee.

16. The method of claim 1 in which step (c) further includes transmitting a record of the transfer of goods or services to the member buyer and its financial institution, and to the member seller and its financial institution.

17. A method of buying and selling goods and services among members of a network including financial institutions, comprising:
(a) conducting a credit check on prospective participants in the network;
(b) assigning a credit limit of derivatives to each participant which has qualified as a network member;
(c) assigning a required reserve contribution for each member for deposit with its financial institution;
(d) determining a working balance of derivatives for each member equal to the sum of available credit from the assigned credit limit and the balance of recorded sales of goods or services made by that member;
(e) executing a transfer of goods or services between members of the network including:
(i) transmitting a purchase request from a member buyer to a member seller;
(ii) approving the purchase request in the event the amount of the purchase is less than the working balance of derivatives of the member buyer;
(iii) crediting derivatives to the working balance of the member seller equal to the amount of the purchase;
(iv) debiting derivatives from the working balance of the member buyer equal to the amount of the purchase;
(f) periodically auditing the working balance of derivatives of each member.

18. The method of claim 17 in which step (f) includes determining the balance of recorded sales of each member as of a selected date, and requiring a cash payment from each member whose balance of recorded sales is less than zero as of said selected date in an amount equal to the negative balance.

19. The method of claim 17 in which step (f) includes determining the balance of recorded sales of each member, and limiting future transactions of those members whose balance of recorded sales is less than said required reserve contribution to an exchange of derivatives with other members.

20. The method of claim 17 in which step (f) includes determining the balance of recorded sales of each member, and allowing those members whose balance of recorded sales is greater than said required reserve contribution but less than a predetermined ceiling reserve contribution to redeem the amount of derivatives above said required reserve contribution for cash at a standard discount rate.

21. The method of claim 20 in which step (f) includes determining the balance of recorded sales of each member, and allowing those members whose balance of recorded sales is greater than said ceiling capital contribution to redeem the amount of derivatives above said ceiling reserve contribution for cash at a preferred discount rate.

22. The method of claim 17 in which step (f) includes determining the balance of recorded sales of each member as of a selected date, and preventing those members whose balance of recorded sales is less than zero from executing a transfer of goods or services until such time as the balance of recorded sales is greater than zero.

23. The method of claim 17 in which step (f) includes determining the balance of sales of each member as of a selected date, and requiring those members whose balance of recorded sales is less than zero to execute sales and deposit derivatives in their account so that the balance of recorded sales is zero or greater before such members are permitted to purchase goods or services in the network.
